(19) United States
(12) Patent Application Publication
(10) Pub. No.: US 2015/0042071 A1
(43) Pub. Date: Feb. 12, 2015

(54) APPARATUS INCLUDING POWERED-ACTUATOR ASSEMBLY FOR MOVING LOAD-BEARING FRAME ASSEMBLY RELATIVE TO HITCH ASSEMBLY OF VEHICLE

(71) Applicant: Robert A. Hamm, Redcliff (CA)

(72) Inventor: Robert A. Hamm, Redcliff (CA)

(21) Appl. No.: 13/962,724

(22) Filed: Aug. 8, 2013

(51) Int. Cl. B60D 1/64

(52) U.S. Cl. CPC B60D 1/64
USPC 280/477

(57) ABSTRACT

An apparatus is for a tool box and a vehicle having a hitch assembly. The apparatus includes a frame assembly and a powered-actuator assembly. The frame assembly is configured to be load bearing, and is also configured to facilitate secured connection with the hitch assembly of the vehicle. The powered-actuator assembly is configured to be powered by a power source, and is also configured to move the frame assembly relative to the hitch assembly of the vehicle in such a way as to facilitate secured connection between the frame assembly and the hitch assembly. The powered-actuator assembly is fixedly connected to the frame assembly. The frame assembly is configured to supportably receive the tool box. The frame assembly is selectively removable from the tool box.

### TECHNICAL FIELD

Some aspects are generally related to (and are not limited to) an apparatus for use with a vehicle having a hitch assembly. More specifically, some aspects provide an apparatus including a frame assembly and a powered-actuator assembly for moving the frame assembly relative to the hitch assembly in such a way as to facilitate secured connection between the frame assembly and the hitch assembly.

### BACKGROUND

A vehicle hitch (also called a trailer hitch, a tow hitch or a tow bar) is a device attached to the chassis of a vehicle. The vehicle hitch can take the form of a tow-ball to allow swiveling and articulation of a trailer, or a tow pin and jaw with a trailer loop often used for large or agricultural vehicles where slack in the pivot pin allows the same movements. The vehicle hitch comes in various configurations such as the receiver type and the fixed-drawbar type. The receiver-type hitch includes a portion that mounts to a frame of the vehicle that has a rearward-facing opening that accepts removable ball mounts, hitch bike racks, cargo carriers, or other hitch-mountable accessories. The fixed-drawbar hitch is built as one piece, has an integrated hole for the trailer ball, and is generally not compatible with after-market hitch accessories.

The vehicle hitch is fixedly connected (or is bolted to) to the chassis of the vehicle. In North America there are a few common classes, such as Classes I, II, III, IV that are defined by the SAE (Society of Automotive Engineers). Some manufacturers market Class V hitches, but there is no such thing according to SAE Standard Number J684. Class I has a range of up to about 2,000 pounds (lbs.) or about 910 kilograms (kg). Class II has a range of up to about 3,500 lbs. (about 1,600 kg). Class III has a range of up to about 5,000 lbs. (about 2,300 kg). Class IV has a range of up to about 10,000 lbs. (about 4,500 kg) for larger loads.

The receiver-type hitch is provided with a square receiver opening of: (A) 1.25 inches (32 millimeters (mm)) for Classes I or II, and (B) 2 inches (51 mm) for Classes III, IV or V. Some Class IV or V hitches are available in 2.5 inches (64 mm) opening sizes.

The trailer tongue (North America) or coupling (outside North America) slips over a tow-ball. Tow-balls come in various sizes depending on the load they carry and the country of operation. In North America, the ball attaches to a ballmount. The receiver-type hitch uses removable ball mounts, whereas the fixed drawbar-type hitch has an integrated ball mount. The ball mount must match the SAE hitch class. The ballmount for a receiver-type hitch is a rectangular bar that fits into a receiver attached to the vehicle. Removable ball mounts are offered with varying rise or drop to accommodate variations in the height of the vehicle and trailer to provide for level towing. In order to tow safely, the correct combination of vehicle and trailer must be combined with correct loading horizontally and vertically on the tow-ball.

Outside North America, the vehicle mounting for the tow-ball is called the tow-bracket. The mounting points for all recent passenger vehicles are defined by the vehicle manufacturer and the tow-bracket manufacturer must use these mount points and prove the efficacy of their bracket for each vehicle by a full rig-based fatigue test.

Many pickup trucks come equipped with one to three mounting holes placed in the center area of a rear bumper to accommodate the mounting of a trailer tow-ball. Some are used by drivers in a rural area for towing wide farm equipment on two-lane roads. A far side mounting allows for the item (a trailer, etc.) being towed to be further away from the opposite side of the road (away from oncoming traffic).

Caution is used when using the bumper of a pickup truck for towing rather than using a frame mounted-receiver hitch, as the bumper does not provide for as much strength and therefore is generally used to tow lighter types of loads. Weight ratings for both bumper-mounted and frame-mounted receiver hitches can be found on the bumper of a pickup truck (for bumper-mounted trailer tow balls) and on the receiver hitches (for frame mounted receiver hitches). Many pickup trucks without frame-mounted receiver hitches often use the rear bumper, especially if the pickup truck is a light duty (not full size) pickup truck.

### SUMMARY

I, the inventor, have researched a problem associated with conveyance of a load to and from a work site. After much study, I believe I have arrived at an understanding of the problem and its solution, which are stated below.

Some types of work require the conveyance of a load (goods and/or tools), perhaps by a container box, to a work site (an area where work takes place by workers and/or by contractors). Sometimes the load is manually loaded on to a vehicle and off from the vehicle (such as a truck or a trailer attached to the truck). The load should be deposited on a work site with minimum effort or inconvenience from the vehicle. In order to convey the load to the work site and then to pick up the load from the work site at a later time, a vehicle having vehicle hitch may be used for such a purpose. The load should be hauled by way of the vehicle via the hitch assembly. To simplify the handling of the load, it is necessary to employ a frame that can be attached to a tow hitch located at the rear of vehicles.

I, the inventor, have provided an apparatus that overcomes the challenge of moving a load having a large weight to and from work sites by using a vehicle having a vehicle hitch.

In order to mitigate, at least in part, the problems identified above, in accordance with another aspect of my work, I (the inventor) have developed an apparatus for use with a vehicle having a hitch assembly is disclosed. The apparatus includes a frame assembly configured to be load bearing. The frame assembly is also configured to facilitate secured connection with the hitch assembly of the vehicle. The apparatus also includes a powered-actuator assembly configured to be powered by a power source. The powered-actuator assembly is also configured to move the frame assembly relative to the hitch assembly of the vehicle in such a way as to facilitate secured connection between the frame assembly and the hitch assembly.

In order to mitigate, at least in part, the problems identified above, in accordance with another aspect of my work, I (the inventor) have developed an apparatus for use with a vehicle having a hitch assembly. The apparatus includes a frame assembly configured to be load bearing, and also configured to facilitate secured connection with the hitch assembly of the vehicle. A powered-actuator assembly is configured to be powered by a power source. The powered-actuator assembly is also configured to move the frame assembly relative to the hitch assembly of the vehicle. This is done in such a way as to facilitate secured connection between the frame assembly and the hitch assembly.

In order to mitigate, at least in part, the problems identified above, in accordance with another aspect of my work, I (the inventor) have developed an apparatus including a vehicle having a hitch assembly. The apparatus also includes a frame assembly configured to be load bearing, and also configured to facilitate secured connection with the hitch assembly of the vehicle. The apparatus also includes a powered-actuator assembly configured to be powered by a power source. The powered-actuator assembly is also configured to move the frame assembly supporting the load relative to the hitch assembly of the vehicle in such a way as to facilitate secured connection between the frame assembly and the hitch assembly.

In order to mitigate, at least in part, the problems identified above, in accordance with another aspect of my work, I (the inventor) have developed a method of operating a hitch assembly of a vehicle. The method includes powering a powered-actuator assembly in such a way that the powered-actuator assembly moves a frame assembly (configured to be load bearing) relative to the hitch assembly of the vehicle in such a way as to facilitate secured connection between the frame assembly and the hitch assembly.

In order to mitigate, at least in part, the problems identified above, in accordance with another aspect of my (our) work, I (the inventor) have developed and provided other aspects as provided in the claims.

By using the apparatus, the challenge of moving the load from work site to work site is overcome at least in part. For example, a contractor may use the apparatus for moving a tool box (an example of the load). A person may use the apparatus to convey a load, perhaps placed in a container, by placing he load on the apparatus, and then connecting the apparatus to the vehicle hitch of the vehicle. For example, the load may include a lockable box having expensive tools that must be conveyed from location to location as may be required to perform work.

Other aspects and features of the non-limiting embodiments may now become apparent to those skilled in the art upon review of the following detailed description of the non-limiting embodiments with the accompanying drawings.

### BRIEF DESCRIPTION OF DRAWINGS

The non-limiting embodiments may be more fully appreciated by reference to the following detailed description of the non-limiting embodiments when taken in conjunction with the accompanying drawings, in which:

FIGS. 1A to 1D (Sheet 1) depicts a side view of schematic examples of an apparatus for use with a vehicle.

FIG. 2 (Sheet 2) depicts a perspective view of a schematic example of the apparatus of FIGS. 1A to 1D.

FIG. 3 (Sheet 3) depicts a perspective view of a schematic example of a load supported by the apparatus of FIGS. 1A to 1D.

FIGS. 4A to 4D (Sheet 4) depicts schematic examples of the apparatus of FIGS. 1A to 1D.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in commercially feasible embodiments are often not depicted in order to facilitate a less obstructed view of these various embodiments of the present disclosure.

### LISTING OF REFERENCE NUMERALS USED IN THE DRAWINGS

100 apparatus
102 frame assembly
104 powered-actuator assembly
106 hitch-interface assembly
120 load-support surface
122 spaced-apart columns
123 first frame section
124 second frame section
140 movable shaft
141 actuator bracket
142 wheel assembly
143 leg assembly
144 wheel-storage device
145 wheel-lock mechanism
146 electric connector
147 switch assembly
148 mechanical connector
149 electric actuator
160 plate assembly
162 hitch-extender assembly
164 hitch-bar receiver
166 storage pin
170 light assembly
200 vehicle
202 hitch assembly
204 load

### DETAILED DESCRIPTION OF THE EXEMPLARY EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”.

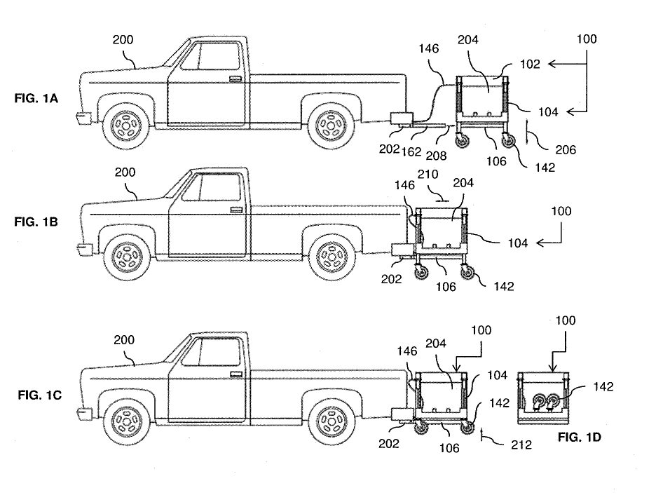

FIGS. 1A to 1D (Sheet 1) depicts a side view of schematic examples of an apparatus 100 for use with a vehicle 200.

Hereafter, it will be appreciated that the description identifies and describes options and variations of the apparatus 100, regardless of whether the description identifies the options and/or variations of the apparatus 100 by way of explicit terms and/or non-explicit terms.

In accordance with a first general option, the apparatus 100 is for use with the vehicle 200 having a hitch assembly 202. In this general option, the apparatus 100 is sold as an after-market item to existing vehicles already deployed to the public at large. The apparatus 100 includes (and is not limited to) a frame assembly 102 configured to facilitate secured connection with the hitch assembly 202 of the vehicle 200. The apparatus 100 also includes a powered-actuator assembly 104 configured to be powered by a power source. The powered-actuator assembly 104 is also configured to move the frame assembly 102 relative to the hitch assembly 202 of the vehicle 200. The frame assembly 102 is moved by the powered-actuator assembly 104 in such a way as to facilitate secured connection between the frame assembly 102 and the hitch assembly 202.

In accordance with a second general option, the apparatus 100 is installed (mounted to) vehicles during the manufacturing of the vehicles, and then the combination of the vehicle 200 and the apparatus 100 are sold as an integrated product to the public at large. The apparatus 100 includes a combination of the vehicle 200, the frame assembly 102 and the powered-actuator assembly 104.

In view of the foregoing, a method of operating the hitch assembly 202 of the vehicle 200 is appreciated. The method includes (and is not limited to) powering the power source of the powered-actuator assembly 104 in such a way that the powered-actuator assembly 104 moves the frame assembly 102 relative to the hitch assembly 202 of the vehicle 200 in such a way as to facilitate secured connection between the frame assembly 102 and the hitch assembly 202. The frame assembly 102 is configured to be load bearing (that is, to bear the load 204).

The frame assembly 102 is defined as an assembly that is configured to receive and to bear (to support) the load 204 once the frame assembly 102 receives and supports the load 204. A frame is defined as a rigid structure formed of relatively slender or smaller pieces, joined so as to surround sizable empty spaces or nonstructural panels. The load 204 is defined as a heavy or bulky object (alive or not alive) that can be carried or is about to be carried.

The frame assembly 102 is further configured to support a load 204 once the frame assembly 102 receives the load 204. The powered-actuator assembly 104 is further configured to move the frame assembly 102 supporting the load 204 relative to the hitch assembly 202 of the vehicle 200. The powered-actuator assembly 104 is configured to move the frame assembly 102 supporting the load 204 in such a way as to facilitate secured connection between the frame assembly 102 and the hitch assembly 202.

More specifically, the powered-actuator assembly 104 is further configured to move the frame assembly 102 between a hitch-connection position (as shown in FIG. 1B) and a non-hitch position (as shown in FIG. 1A). In the hitch-connection position, the frame assembly 102 is positioned for operative secured connection to the hitch assembly 202 in such a way that the vehicle 200 fully supports the frame assembly 102 receiving the load 204. In the non-hitch position, the frame assembly 102 is spaced apart from the hitch assembly 202 in such a way that the vehicle 200 does not support the frame assembly 102 receiving the load 204.

The frame assembly 102 includes a hitch-interface assembly 106. The hitch-interface assembly 106 is securely coupled to the frame assembly 102. The hitch-interface assembly 106 is configured to facilitate secured connection with the hitch assembly 202 of the vehicle 200. The powered-actuator assembly 104 is also configured to move the frame assembly 102 supporting the load 204 relative to the hitch assembly 202 of the vehicle 200. The powered-actuator assembly 104 moves (in use) the frame assembly 102 in such a way as to facilitate secured connection between the hitch-interface assembly 106 of the frame assembly 102 and the hitch assembly 202.

Referring to FIG. IA, the load 204 is received by and supported by the frame assembly 102. The vehicle 200 is moved close to the apparatus 100. The powered-actuator assembly 104 is connected, via an electric connector 146, to a power source such as an electric circuit of the vehicle 200 connected to a battery (not depicted and known) of the vehicle 200. A hitch-extender assembly 162 is fixedly attached to the hitch assembly 202. The frame assembly 102 is adapted to receive the hitch-extender assembly 162 via the hitch-interface assembly 106. The powered-actuator assembly 104 is power actuated to move the frame assembly 102 either up or down (along a direction 206) relative to the hitch assembly 202 until the hitch-extender assembly 162 is horizontally level with the hitch-interface assembly 106. The frame assembly 102 is moved toward (along a direction 208) the vehicle 200 so the hitch-extender assembly 162 is slidably received by the hitch-interface assembly 106. For the case where the hitch-extender assembly 162 is not horizontally level with the hitch-interface assembly 106, instances of the powered-actuator assembly 104 (located close to (proximate to) the vehicle 200) may be actuated independently from the instances of the powered-actuator assembly 104 (located further away from (distal of) the vehicle 200). In this manner, horizontal alignment between the hitch-extender assembly 162 and the hitch-interface assembly 106 may be accommodated or achieved by independent actuation of the instances of the powered-actuator assembly 104.

Referring to FIG. 1B, the apparatus 100 is moved along a direction 210 in such a way that the hitch-extender assembly 162 is received by the hitch-interface assembly 106, and the instances of the wheel assembly 142 remain in contact with the ground. In FIG. 1B, the hitch-extender assembly 162 is hidden from view.

Referring to FIG. 1C, the powered-actuator assembly 104 is powered in such a way that the instances of the wheel assembly 142 are moved along a direction 212 to a wheel-retracted position in which the instances of the wheel assembly 142 are spaced apart from the ground.

Referring to FIG. 1D, the instances of the wheel assembly 142 may be removed (detached), if so desired, from the apparatus 100. The instances of the wheel assembly 142 may be stored as depicted in a wheel-storage position if so desired.

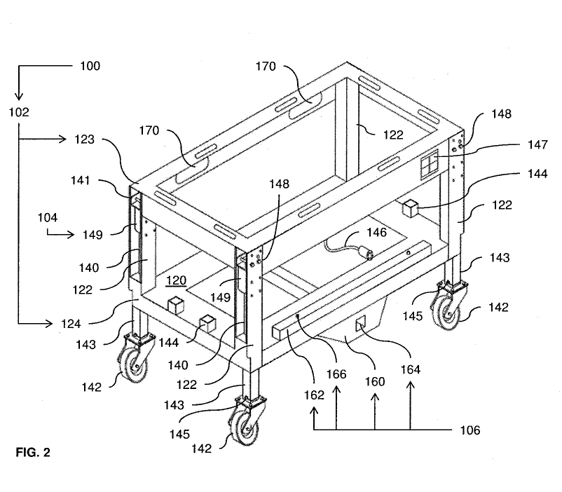

According to one example, the apparatus 100 provides the frame assembly 102 having instances of the wheel assembly 142 that are power extendable at the four corners of the frame assembly 102. The wheel assembly 142 go up to allow separation, putting weight on the hitch assembly 202 of the vehicle 200, then go down to allow the frame assembly 102 to roll away from the hitch assembly 202 and move the load 204 to any position on site with reduced effort. In accordance with a case where the frame assembly 102 includes the instances of the wheel assembly 142 positioned at the four corners of the frame assembly 102, the instances of the wheel assembly 142 may be extended (and retracted) by any suitable powered actuator (such as, an electric actuator 149 as depicted in FIG. 2, a mechanical actuator, a pneumatic actuator or a hydraulic actuator). The attachment of the frame assembly 102 to the hitch assembly 202 of the vehicle 200 can be managed by extending or retracting the wheel assembly 142. The electric source for raising and lowering the wheel assembly 142 is available from a 12 volt battery or using the battery of the vehicle 200 by connecting the frame assembly 102 with a common trailer power plug which allows the vehicle 200 to supply available electric power. Once the hitch assembly 202 is securely engaged to the frame assembly 102, and the instances of the wheel assembly 142 may be retracted, then the frame assembly 102 receives the load 204, and the frame assembly 102 may be moved by the vehicle 200. When the vehicle 200 arrives at a destination, the instances of the wheel assembly 142 may be lowered taking the weight of the load 204, and then the frame assembly 102 may be unhitched and rolled away from the vehicle 200. Alternatively, for the case where the instances of the wheel assembly 142 are not included with the apparatus 100, then the frame assembly 102 may be deposited to the ground (as is).

FIG. 2 (Sheet 2) depicts a perspective view of a schematic example of the apparatus 100 of FIGS. 1A to 1D.

In accordance with the example depicted in FIG. 2, the powered-actuator assembly 104 is supported by and connected to the frame assembly 102.

The frame assembly 102 includes a load-support surface 120 and spaced-apart columns 122. The spaced-apart columns 122 are fixedly connected to and extend from the load-support surface 120. Each instance of the spaced-apart columns 122 is configured to connect to an instance of the powered-actuator assembly 104. Each instance of the powered-actuator assembly 104 has a movable shaft 140 configured to move in response to powered actuation of the powered-actuator assembly 104. Each instance of the movable shaft 140 is movable between the hitch-connection position (as shown in FIG. 1B) and a non-hitch position (as shown in FIG. 1A). In the hitch-connection position, the frame assembly 102 is positioned for operative secured connection to the hitch assembly 202 in such a way that the vehicle 200 fully supports the frame assembly 102 receiving the load 204. In the non-hitch position, the frame assembly 102 is spaced apart from the hitch assembly 202 in such a way that the vehicle 200 does not support the frame assembly 102 receiving the load 204 (the vehicle 200 and the load 204 are depicted in FIGS. 1A, 1B, 1C).

Each instance of an actuator bracket 141 is configured to mount the instances of the powered-actuator assembly 104 (along with respective instances of the movable shaft 140) to respective instances of the spaced-apart columns 122. Each instance of the movable shaft 140 includes a leg assembly 143 connected to a respective instance of the movable shaft 140. Each instance of the movable shaft 140 includes a wheel assembly 142 mounted to a respective instance of the movable shaft 140. Each instance of the leg assembly 143 extends from a respective instance of the wheel assembly 142. Each instance of the leg assembly 143 is connected to a respective instance of the movable shaft 140. Instances of a wheel-storage device 144 are attached to the frame assembly 102, and each instance of the wheel-storage device 144 is configured to receive and store a respective instance of the wheel assembly 142.

If desired, a wheel-lock mechanism 145 is configured to selectively lock and unlock an instance of the wheel assembly 142 to a respective instance of the leg assembly 143. The leg assembly 143 extends from a respective movable shaft 140. If so desired, the wheel-lock mechanism 145 may be in the form of a pin.

The frame assembly 102 further includes a first frame section 123 and a second frame section 124 spaced apart from the first frame section 123. The spaced-apart columns 122 extend between the first frame section 123 and the second frame section 124. The first frame section 123 is positioned above the second frame section 124. The second frame section 124 is positioned closer to the ground relative to the first frame section 123. The second frame section 124 includes the load-support surface 120.

The first frame section 123 includes parallel side-by-side longitudinal-extending members that are spaced apart from each other. The parallel side-by-side longitudinal-extending members have a length what may span the width of the vehicle 200 of FIG. 1A. The first frame section 123 also includes spaced-apart members positioned on opposite sides of (and extending between) the parallel side-by-side longitudinal-extending members. The members of first frame section 123 are attached so as to form a rectangular-shaped structure. The second frame section 124 may have the same configuration as the configuration of the first frame section 123 (if so desired).

According to a specific option, the hitch-interface assembly 106 includes a plate assembly 160, a hitch-bar receiver 164, a hitch-extender assembly 162, and a storage pin 166. The plate assembly 160 extends from opposite sides of the second frame section 124. The hitch-bar receiver 164 is attached to the plate assembly 160. The hitch-extender assembly 162 is configured to be received by the hitch-bar receiver 164. The hitch-extender assembly 162 is configured for secured connection to the hitch assembly 202 of the vehicle 200. The storage pin 166 extends from the frame assembly 102 (from the second frame section 124). The storage pin 166 is configured to be received in a corresponding hole defined by the hitch-extender assembly 162; in this manner, the hitch-extender assembly 162 may be securely received in a storage position relative to frame assembly 102 (specifically, to the second frame section 124).

The powered-actuator assembly 104 includes a power cord 146 and a switch assembly 147. The switch assembly 147 is connected to the power cord 146. Each instance of the powered-actuator assembly 104 includes an electric actuator 149 and a mechanical connector 148 (such as a bolt and nut). The electric actuator 149 is connected to the switch assembly 147. The mechanical connector 148 fixedly connects an instance of the electric actuator 149 to a respective instance of the spaced-apart columns 122.

The frame assembly 102 includes a light assembly 170 configured to provide light once actuated to do just so. The light assembly 170 may be used to alert following motorists.

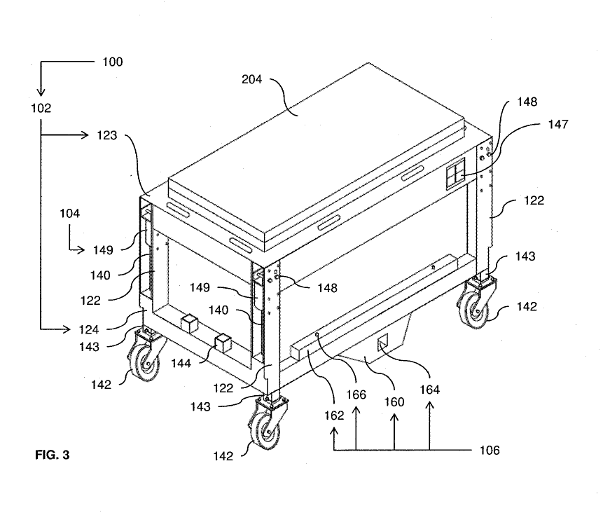

FIG. 3 (Sheet 3) depicts a perspective view of a schematic example of the load 204 supported by the apparatus 100 of FIGS. 1A to 1D.

FIG. 3 depicts the instances of the leg assembly 143 in a retracted position (corresponding with FIG. 1C). FIG. 2 depicts the instances of the leg assembly 143 in an extended position (corresponding with FIG. 1B). FIG. 3 depicts the frame assembly 102 receiving and supporting the load 204. Generally speaking, the frame assembly 102 is configured to receive and to support the load 204. FIGS. 2 and 3 depict a three-dimensional rendering of an example of the apparatus 100. By way of example, the apparatus 100 may be configured to support a storage box. The storage box may have a dimensional footprint of about 42 inches to about 46 inches.

According to a specific example, the frame assembly 102 includes a reinforced rectangular frame or cage that has four instances of the powered-actuator assembly 104 built into the corners of the frame assembly 102 (along the spaced-apart columns 122. The instances of the powered-actuator assembly 104 extend vertically. Each of the instances of the powered-actuator assembly 104 are configured to raise or lower a respective instance of the movable shaft 140 to which is attached an instance of the wheel assembly 142 having sufficient strength to carry or to support the load 204. For example, the load 204 that may be used is up to about 400 pounds for each instance of the wheel assembly 142 (if so desired). If so desire, the instances of the wheel assembly 142 may be eight inches in diameter to allow the apparatus 100 to be rolled over moderately uneven surfaces, such as a gravel surface, commonly found at locations associated with work sites. The wheel assembly 142 may be varied in size if so desired.

The instances of the powered-actuator assembly 104 are positioned at the corners of the frame assembly 102. The instances of the powered-actuator assembly 104 are connected to the frame assembly 102 by using plates and bolts. The raising and lowering of the wheel assembly 142 on the movable shaft 140 (also called columns) may be handled by installing an electric-mechanical actuator. The powered-actuator assembly 104 is controllable by the switch assembly 147. The switch assembly 147 includes a first switch configured to cause the powered-actuator assembly 104 to raise or to lower a pair of the wheel assembly 142 (positioned in the rear of the apparatus 100). The switch assembly 147 includes another switch configured to raise or to lower a pair of the wheel assembly 142 (positioned in the front of the apparatus 100). This arrangement accomplishes or facilitates tilting or alignment of the hitch-bar receiver 164 in order to match the horizontal alignment of the hitch-extender assembly 162 that is connected to the hitch assembly 202 (as depicted in FIG. 1B). In this manner, the powered-actuator assembly 104 is configured to facilitate alignment of the hitch-bar receiver 164 with the hitch-extender assembly 162 on the same horizontal elevation (for the case where the ground is uneven). Simultaneous activation of both switches of the switch assembly 147 causes the instances of the powered-actuator assembly 104 to raise or lower the frame assembly 102 to accomplish transport position (wheels up as depicted in FIG. 1C) or roll-away position (wheels down as depicted in FIG. 1B).

To adapt the frame assembly 102 to different sizes of storage boxes and uses, the measurements of the frame assembly 102 may be revised as desired. Similarly, to accommodate pneumatic or hydraulic actuation of the powered-actuator assembly 104, appropriate control devices may be used as required. It is expected that a preferred option provides the powered-actuator assembly 104 including an electric actuator 149, such as an electric-powered screw-type activator device, that may be powered by using 12 volt power available through a trailer hitch electric plug (known and not depicted) positioned on the vehicle 200.

In accordance with an option, the apparatus 100 includes four instances of the wheel assembly 142 operatively affixed to the corners of the frame assembly 102 by way of instances of the movable shaft 140 (or columns). The instances of the movable shaft 140 are attached (directly or indirectly) to the wheel assembly 142 (at the base of the frame assembly 102). The movable shaft 140 may be propelled up or down by the powered-actuator assembly 104 in such a way as to raise and to lower the instances of the wheel assembly 142 necessary to raise (load) and lower (unload) the apparatus 100 onto the hitch assembly 202 of the vehicle 200 (by using a hitch-interface assembly 106). The powered-actuator assembly 104 may include a screw device, a pneumatic-pressure device, a hydraulic-pressure device or a mechanical device (if so desired).

The frame assembly 102 is attached by using the hitch-extender assembly 162 configured to fit with the hitch assembly 202. By way of example, the hitch-extender assembly 162 includes a bar or a tongue having a square-shaped cross-sectional profile.

The switch assembly 147 (also called a control system) receives electric power from a trailer plug connected to a battery (such as the battery of the vehicle 200), so that the switch assembly 147 controls the powered-actuator assembly 104 to raise or lower the instances of the wheel assembly 142 (either separately or simultaneously in pairs) so the rear section or the front section of the frame assembly 102 is raised or lowered.

According to an option, the apparatus 100 may include a retractable wheel system having sufficient height and retracting capacity when used; in addition, a power source (such as the trailer plug of the vehicle 200 or other power source) may be connected to provide power to the powered-actuator assembly 104 of the apparatus 100. The powered-actuator assembly 104 is configured to move the wheel assembly 142 in the up position or the down position while remaining securely attached to the frame assembly 102 (if so desired). The frame assembly 102 may be secured to the load 204, or may be disconnected from the load 204 (as may be required or desired).

The frame assembly 102 may be secured to the hitch assembly 202 so that the danger of break-away from the hitch assembly 202 during travel is reduced. When the wheel assembly 142 is used, the frame assembly 102 may be conveniently rolled away. The hitch-extender assembly 162 facilitates a safer transfer of the load 204.

The light assembly 170 (as depicted in FIG. 2) provides a safer conveyance since the light assembly 170 synchronizes with the tail lights of the vehicle 200 for braking. For example, the battery of the vehicle 200 may provide a convenient power source that may be used to lift about 1,800 lbs. (about 450 lbs. per corner of the frame assembly 102). This arrangement may be more acceptable for situations in which the load 204 includes a contractor boxes that hold valuable and heavy tools. The apparatus 100 may be easy to disconnect with no tools or effort from the hitch assembly 202. The height adjustment before disconnection of the power cord 146 (depicted in FIG. 2) leaves the load 204 at a level that is safer and more stable; as well, the top section of the load 204 can be positioned by using the powered-actuator assembly 104, and in this way the load 204 may provide a convenient table height.

Overall, the apparatus 100 may be configured for rugged use by professional contractors having large and heavy tool boxes. Reliable performance with changing conditions for power hook-up, travel and job-site usage may be facilitated by the apparatus 100.

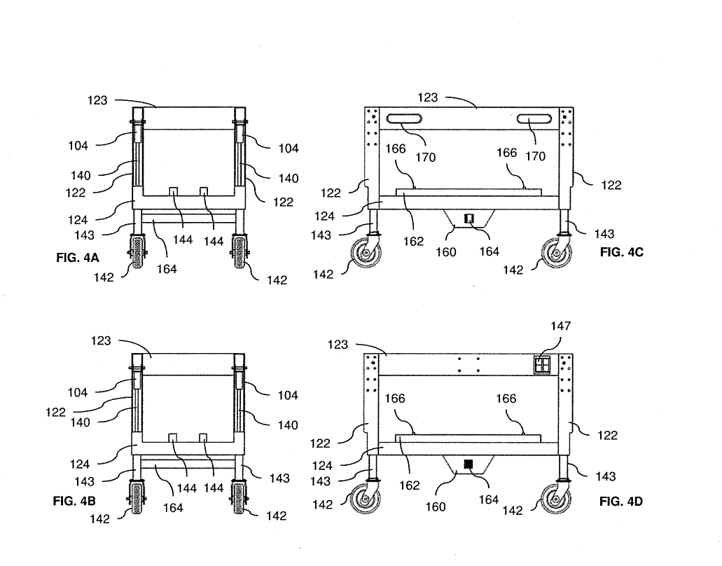

FIGS. 4A to 4D (Sheet 4) depicts schematic examples of the apparatus 100 of FIGS. 1A to 1D. FIGS. 4A and 4B depict the end views. FIGS. 4C and 4D depict the side views.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, or components that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1. An apparatus for a tool box and a vehicle having a hitch assembly, the apparatus comprising:
a frame assembly being configured to be load bearing, and also being configured to facilitate secured connection with the hitch assembly of the vehicle; and
a powered-actuator assembly being configured to be powered by a power source, and the powered-actuator assembly also being configured to move the frame assembly relative to the hitch assembly of the vehicle in such a way as to facilitate secured connection between the frame assembly and the hitch assembly; and
the frame assembly being configured to supportably receive and surround the tool box in such a way as to prevent lateral movement of the tool box once received by the frame assembly;
the frame assembly being selectively removable from the tool box;
the powered-actuator assembly being fixedly connected to the frame assembly; and
the powered-actuator assembly extending along a vertical length of the frame assembly.

2. The apparatus of claim 1, wherein:
the frame assembly is further configured to support a load once the frame assembly receives the load; and
the powered-actuator assembly is further configured to move the frame assembly supporting the load relative to the hitch assembly of the vehicle in such a way as to facilitate secured connection between the frame assembly and the hitch assembly.

3. The apparatus of claim 1, wherein:
the powered-actuator assembly is further configured to move the frame assembly between a hitch-connection position and a non-hitch position.

4. The apparatus of claim 3, wherein:
in the hitch-connection position, the frame assembly is positioned for operative secured connection to the hitch assembly in such a way that the vehicle fully supports the frame assembly receiving the load; and
in the non-hitch position, the frame assembly is spaced apart from the hitch assembly in such a way that the vehicle does not support the frame assembly receiving the load.

5. The apparatus of claim 1, wherein:
the powered-actuator assembly is supported by and connected to the frame assembly.

6. The apparatus of claim 1, wherein:
the frame assembly includes:
a hitch-interface assembly being securely coupled to the frame assembly, and the hitch-interface assembly being configured to facilitate secured connection with the hitch assembly of the vehicle; and
the powered-actuator assembly is also configured to:
move the frame assembly supporting the load relative to the hitch assembly of the vehicle in such a way as to facilitate secured connection between the hitch-interface assembly of the frame assembly and the hitch assembly.

7. The apparatus of claim 6, wherein:
the powered-actuator assembly is also configured to:
move the frame assembly supporting the load relative to the hitch assembly of the vehicle in such a way as to facilitate secured connection between the hitch-interface assembly of the frame assembly and the hitch assembly.

8. The apparatus of claim 1, wherein:
the frame assembly includes:
a load-support surface; and
spaced-apart columns being fixedly connected to and extending from the load-support surface, and each instance of the spaced-apart columns being configured to connect to an instance of the powered-actuator assembly.

9. The apparatus of claim 8, wherein:
each instance of the powered-actuator assembly has a movable shaft being configured to move in response to powered actuation of the powered-actuator assembly; and
each instance of the movable shaft being movable between a hitch-connection position and a non-hitch position.

10. The apparatus of claim 9, wherein:
each instance of the movable shaft includes:
a leg assembly connected to a respective instance of the movable shaft.

11. The apparatus of claim 10, wherein:
each instance of the movable shaft includes:
a wheel assembly mounted to a respective instance of the movable shaft; and
an instance of the leg assembly extends from a respective instance of the wheel assembly, each instance of the leg assembly is connected to a respective instance of the movable shaft.

12. The apparatus of claim 11, wherein:
instances of a wheel-storage device are attached to the frame assembly, and each instance of the wheel-storage device is configured to receive and store a respective instance of the wheel assembly.

13. The apparatus of claim 8, wherein:
the frame assembly further includes:
a first frame section;
a second frame section spaced apart from the first frame section; and
the spaced-apart columns extend between the first frame section and the second frame section.

14. The apparatus of claim 13, wherein:
the first frame section is positioned above the second frame section;
the second frame section is positioned closer to the ground relative to the first frame section; and
the second frame section includes the load-support surface.

15. The apparatus of claim 6, wherein:
the hitch-interface assembly includes:
a plate assembly extending from the frame assembly;
a hitch-bar receiver attached to the plate assembly.

16. The apparatus of claim 15, wherein:
the hitch-interface assembly further includes:
a hitch-extender assembly being configured to be received by the hitch-bar receiver, and the hitch-extender assembly being configured for secured connection to the hitch assembly of the vehicle.

17. The apparatus of claim 16, wherein:
the hitch-interface assembly further includes:
a storage pin extending from the frame assembly, and the storage pin configured to be received in a corresponding hole defined by the hitch-extender assembly in such a way that the hitch-extender assembly is securely received in a storage position relative to the frame assembly.

18. The apparatus of claim 1, wherein:
the powered-actuator assembly includes:
an electric connector;
a switch assembly being connected to a power cord; and
each instance of the powered-actuator assembly includes:
an electric actuator connected to the switch assembly.

19. The apparatus of claim 18, wherein:
the powered-actuator assembly further includes:
a mechanical connector fixedly connecting an instance of the electric actuator to a respective instance of the spaced-apart columns.

20. The apparatus of claim 1, wherein:
the frame assembly includes:
a light assembly being configured to provide light once actuated to do just so.

21. An apparatus for use with a tool box, comprising:
a vehicle having a hitch assembly;
a frame assembly configured to be load bearing, and also configured to facilitate secured connection with the hitch assembly of the vehicle; and
a powered-actuator assembly being configured to be powered by a power source, and the powered-actuator assembly also being configured to move the frame assembly relative to the hitch assembly of the vehicle in such a way as to facilitate secured connection between the frame assembly and the hitch assembly;
the frame assembly being configured to supportably receive and surround the tool box in such a way as to prevent lateral movement of the tool box once received by the frame assembly;
the frame assembly being selectively removable from the tool box;
the powered-actuator assembly being fixedly connected to the frame assembly; and
the powered-actuator assembly extending along a vertical length of the frame assembly.

22. (canceled)

23. An apparatus for a tool box and a vehicle having a hitch assembly, the apparatus comprising:
a frame assembly being configured to be load bearing, and also being configured to facilitate secured connection with the hitch assembly of the vehicle; and
a powered-actuator assembly being configured to be powered by a power source, and the powered-actuator assembly also being configured to move the frame assembly relative to the hitch assembly of the vehicle in such a way as to facilitate secured connection between the frame assembly and the hitch assembly;
the frame assembly being configured to supportably receive and surround the tool box in such a way as to prevent lateral movement of the tool box once received by the frame assembly;
the frame assembly being selectively removable from the tool box;
the powered-actuator assembly being fixedly connected to the frame assembly; and
the powered-actuator assembly extending along a vertical length of the frame assembly; and
wherein the frame assembly includes:
a load-support surface; and
spaced-apart columns are fixedly connected to and extending from the load-support surface, and each instance of the spaced-apart columns is configured to connect to an instance of the powered-actuator assembly;
each instance of the powered-actuator assembly has a movable shaft configured to move in response to powered actuation of the powered-actuator assembly;
each instance of the movable shaft is movable between a hitch-connection position and a non-hitch position;
each instance of the movable shaft includes a leg assembly connected to a respective instance of the movable shaft;
each instance of the movable shaft includes:
a wheel assembly mounted to a respective instance of the movable shaft; and
an instance of the leg assembly extends from a respective instance of the wheel assembly, each instance of the leg assembly is connected to a respective instance of the movable shaft; and
wherein the powered-actuator assembly includes:
an electric connector;
a switch assembly is connected to a power cord; and
each instance of the powered-actuator assembly includes an electric actuator connected to the switch assembly; and
in the hitch-connection position, the frame assembly is positioned for operative secured connection to the hitch assembly in such a way that the vehicle fully supports the frame assembly receiving the load;
in the non-hitch position, the frame assembly is spaced apart from the hitch assembly in such a way that the vehicle does not support the frame assembly receiving the load; and
the powered-actuator assembly is configured to adjust height of instances of the wheel assembly between an up position and a down position relative to the ground while remaining securely attached to the frame assembly.
